(19) United States
(12) Patent Application Publication
(10) Pub. No.: US 2007/0053790 A1
(43) Pub. Date: Mar. 8, 2007

(54) Analyzing tool being reduced in distance of diffusion of reagent and method for manufacture thereof

(75) Inventors: Kenji Nagakawa, Kyoto-shi (JP); Masaaki Teramoto, Kyoto-shi (JP); Yoshiyuki Kawase, Kyoto-shi (JP); Mitsuhiro Hoshijima, Kyoto-shi (JP)

Correspondence Address: HAMRE, SCHUMANN, MUELLER & LARSON, P.C., P.O. BOX 2902, MINNEAPOLIS, MN, 55402-0902, US

(73) Assignee: ARKRAY, INC., KYOTO-SHI (JP)

(21) Appl. No.: 10/553,336

(22) PCT Filed: Apr. 15, 2004
(86) PCT No.: PCT/JP04/05434

§ 371 Date: Nov. 27, 2006

(30) Foreign Application Priority Data
Apr. 16, 2003 (JP) 2003-111950
Apr. 16, 2003 (JP) 2003-111948

(51) Int. Cl. G01N 21/00

(52) U.S. Cl. 422/55

(57) ABSTRACT

The present invention relates to an analyzing tool (X1) including a reaction space (4) for allowing a particular component contained in a sample and a reagent to react with each other, and a reagent portion (51, 52) which is arranged in the reaction space (4) and which dissolves when the sample is supplied to the reaction space (4). The reagent portion (51, 52) includes a first part (51) and a second part (52) facing each other at a defining surface defining the reaction space (4).

### TECHNICAL FIELD

The present invention relates to an analyzing tool used for analyzing a particular component contained in a sample, and to a method for making such an analyzing tool.

### BACKGROUND ART

FIG. 20 shows a glucose sensor 9, which is an example of analyzing tool used for measuring the blood glucose level by colorimetry. The glucose sensor 9 includes a first and a second plate members 91 and 92 bonded together via a pair of spacers 93. The glucose sensor 9 includes a capillary 94 defined by the above elements 91-93. A reagent 95 is provided in the capillary 94. The reagent 95 dissolves when blood is supplied thereto and contains reactive components such as a color former, an oxidoreductase and an electron mediator, for example.

In the glucose sensor 9, when blood is supplied through an opening 96, the blood introduced into the capillary 94 moves toward an opening 97 by a capillary force generated in the capillary 94. At this time, a liquid phase reaction system including glucose and reactive components is established in the capillary 94 by the dissolving of the reagent 95.

In the liquid phase reaction system, the reactive components contained in the reagent 95 and glucose diffuse to undergo reaction, and electrons taken out from glucose are supplied to the color former via the electron mediator, for example. By the supply of electrons, the color former develops color, whereby the liquid phase reaction system is colored. The degree of coloring is detected by an optical technique, and the blood glucose level is computed based on the detection result.

As noted above, to cause the color former to develop color, at least the reaction for taking out electrons from glucose and the reaction for supplying the taken-out electrons to the color former are necessary. On the other hand, to make the color former efficiently develop color in the liquid phase reaction system and to shorten the measurement time, it is necessary to disperse the reactive component contained in the reagent 95 uniformly in the liquid phase reaction system. However, in the case where the reagent 95 is designed to dissolve by the supply of a sample, the concentration of the reactive component becomes locally high (at the portion where the reagent 95 is provided) and then gradually becomes uniform as the reactive component diffuse over time. Therefore, in the concentration measurement using the glucose sensor 9, the measurement time tends to depend on the diffusivity of the reactive component. Further, although the glucose concentration is generally uniform in the liquid phase reaction system in the initial stage after the blood is introduced into the capillary 94, glucose is consumed as the reaction proceeds, so that the concentration of unreacted glucose is lowered at a region where the concentration of the reactive component is high. Therefore, in addition to the reactive component, the concentration distribution of glucose and the diffusivity of glucose also have influence on the measurement time.

In the glucose sensor 9, the reagent 95 is formed only at the second transparent plate 92, and the distance H between the first transparent plate 91 and the second transparent plate 92 is generally set to no smaller than 200 μm. Therefore, in the diffusion to make the concentration of the reactive component contained in the reagent 95 uniform in the liquid phase reaction system, the diffusion length of the target component is relatively large. Further, the diffusion length of glucose is also large. As a result, the glucose sensor 9 has a drawback that the time taken to obtain an intended reaction state (coloring of the liquid phase reaction system) is relatively long and hence long measurement time is required. When the measurement time is set relatively short, coloring sufficient for the accurate measurement of a high glucose concentration in blood cannot be obtained, so that the measurement accuracy in a high concentration range is deteriorated. To ensure high measurement accuracy while setting the measurement time relatively short, the measurement range becomes narrow.

Further, when an unstable reagent (highly reactive reagent) such as methoxy-PMS as an electron mediator is contained in the reagent 95, such a reagent reacts with another reagent to cause measurement error in storing the glucose sensor 9. Therefore, when a single reagent contains different kinds of reagents, the stability in storage may not be good depending on the combination of the reagents, whereby the measurement accuracy may become lower.

### DISCLOSURE OF THE INVENTION

An object of the present invention is to provide an analyzing tool which is capable of shortening the analysis time and performing accurate analysis even in a high concentration range and which has good stability in storage.

According to a first aspect of the present invention, there is provided an analyzing tool comprising: a reaction space in which a particular component of a sample and a reagent react with each other; and a reagent portion which is arranged in the reaction space and which dissolves when the sample is supplied to the reaction space. The reagent portion includes a first part and a second part facing each other and provided on a defining surface defining the reaction space.

Preferably, the first part and the second part may be separated from each other. It is possible, however, that the first part and the second part are connected to each other.

Preferably, the first part and the second part differ from each other in composition. In this case, reagents which are likely to react with each other in storage are to be separated into the first part and the second part for avoiding mixture. In this manner, the reaction between reagents is prevented from occurring, whereby the stability in storage can be enhanced. On the other hand, reagents which are unlikely to react with each other can be mixed in the first or the second part.

The reagent in the analyzing tool of the present invention may include a color-developing reagent to perform sample analysis by colorimetry. The present invention is also applicable to an analyzing tool for analyzing a sample by an electrode method. In such a case, the reagent need not include a color-developing reagent.

The defining surface includes a first region at which the first part is provided, and a second region at which the second part is provided and which faces the first region in the direction normal to the first region. In this case, it is preferable that the facing distance of the first region and the second region is no greater than 300 μm.

Preferably, the facing distance is no greater than 200 μm, and more preferably, no greater than 150 μm. Meanwhile, the facing distance is no smaller than 30 μm. This is because, when the facing distance is excessively small, a sample containing solid components, like blood containing blood cells, or a sample having a high viscosity cannot move smoothly through the flow path.

The analyzing tool of the present invention may further comprise a first plate member in which the first region is included, and a second plate member in which the second region is included. The second plate member defines the reaction space together with the first plate member. The analyzing tool of the present invention may further comprise a spacer for bonding the first plate member and the second plate member to each other and defining the reaction space together with the plate members. In this case, the facing distance mentioned above can be determined by the spacer.

The reaction space may be designed to move the sample by a capillary force generated in the reaction space. Alternatively, the reaction space may be designed to move the sample by utilizing the motive power of a pump. In the analyzing tool of the present invention, the sample need not necessarily be moved in the reaction space.

According to a second aspect of the present invention, there is provided a method for making an analyzing tool. The method may comprise: a first reagent portion forming step for forming at least one first reagent portion at a first substrate; a second reagent portion forming step for forming at least one second reagent portion at a second substrate; and an intermediate product forming step for forming an intermediate product by bonding the first and the second substrates together in a manner such that the first and the second reagent portions face each other.

Herein, the “first substrate” and “second substrate” can refer to substrates corresponding to the first plate member and the second plate member in the analyzing tool according to the first aspect of the present invention, and also refer to other materials in which a plurality of regions to be divided into such plate members are defined.

Preferably, in the first reagent portion forming step, a plurality of first reagent portions may be formed at the first substrate, and in the second reagent portion forming step, a plurality of second reagent portions may be formed at the second substrate. Preferably, in this case, the method may further comprise a cutting step for cutting the intermediate product into pieces each including at least one of the first reagent portions and at least one of the second reagent portions.

The first reagent portion and the second reagent portion may differ from each other in composition. In this case, an analyzing tool can be provided in which a highly reactive reagent is separated from another reagent which is likely to react with the reagent. However, the first reagent portion and the second regent portion may have the same or substantially the same composition.

Preferably, the method according to the present invention may further comprise a step performed before the intermediate product forming step for mounting a spacer on at least one of the first and the second substrates, wherein the spacer is mounted on a surface to be formed with the first reagent portion or a surface to be formed with the second reagent portion. Preferably, this additional step may be performed before forming the first and the reagent portions at the first and the second substrates. In such a case, the region at which a reagent portion is to be formed can be defined by the spacer, and it is possible to prevent the spacer from being mounted on a region formed with a reagent portion. However, it is possible that this step may be performed after the first and the second reagent portions are formed.

As the spacer, use may be made of a double-sided tape having adhesive opposite sides, for example. In this case, the application of an adhesive on the first or the second substrate is unnecessary, whereby the manufacturing efficiency of an analyzing tool is enhanced.

According to a third aspect of the present invention, there is provided an analyzing tool comprising a reaction space in which a particular component of a sample reacts with a reagent for analyzing the particular component by colorimetry. The reaction space is defined by a defining surface which includes: a reagent retaining region for retaining a reagent; and a facing region which faces the reagent retaining region in the direction normal to the reagent retaining region. The facing region does not retain a reagent. The facing distance of the reagent retaining region and the facing region is no greater than 150 μm.

Preferably, the facing distance may be no greater than 100 μm, and more preferably, no greater than 75 μm. On the other hand, the facing distance may be no smaller than 30 μm. This is because, when the facing distance is excessively small, a sample containing solid components, like blood containing blood cells, or a sample having a high viscosity cannot move smoothly through the flow path.

The reaction space may be designed to cause the sample to move therein. The movement of the sample may be realized by a capillary force generated in the reaction space. Alternatively, the sample in the reaction space may be moved by a motive power from a pump.

The analyzing tool of the present invention may further comprise a first plate member in which the reagent retaining region is included, and a second plate member in which the facing region is included. The second plate member defines the reaction space together with the first plate member. The analyzing tool of the present invention may further comprise a spacer for bonding the first plate member and the second plate member to each other and defining the reaction space together with the plate members. In this case, the facing distance may be determined by the spacer.

The present invention is applicable to an analyzing tool for a sample such as blood. The present invention is also applicable to an analyzing tool used for analyzing a sample other than blood, for example, urine.

In the specification of the present invention, the term “facing” indicates not only the facing state of flat surfaces but also the facing state of curved surfaces and the facing state of a flat surface and a curved surface, unless otherwise noted. Further, the term “facing distance” means the maximum value of distance necessary for a reagent to travel for reaching the facing region when the reagent is diffused from the reagent retaining region in the normal direction.

### BRIEF DESCRIPTION OF THE DRAWINGS

FIG. 1 is an entire perspective view showing a glucose sensor according to a first embodiment of the present invention.

FIG. 2 is a sectional view taken along the line II-II in FIG. 1.

FIG. 3 is a sectional view taken along the line III-III in FIG. 1.

FIGS. 4A and 4B each is a sectional view corresponding to FIG. 3 for describing the progress of blood in a capillary.

FIG. 5 is an entire perspective view of a substrate used in a method for making the glucose sensor shown in FIGS. 1-3.

FIG. 6 is an entire perspective view of the substrate shown in FIG. 5, to which double-sided tapes are bonded.

FIG. 7 is an entire perspective view of a primary intermediate product obtained by forming a plurality of reagent portions on the substrate shown in FIG. 6.

FIG. 8 is an entire perspective view showing the process step for bonding two primary intermediate products together.

FIGS. 9A-9D each is a sectional view showing another example of glucose sensor according to the present invention.

FIG. 10A is a perspective view, partially cut away, showing still another example of glucose sensor according to the present invention, and FIG. 10B is a sectional view thereof.

FIG. 11 is an entire perspective view showing a glucose sensor according to a second embodiment of the present invention.

FIG. 12 is a sectional view taken along the line XII-XII in FIG. 11.

FIG. 13 is a sectional view taken along the line XIII-XIII in FIG. 11.

FIGS. 14A and 14B each is a sectional view corresponding to FIG. 13 for describing the progress of blood in a capillary.

FIG. 15A is a perspective view, partially cut away, showing another example of glucose sensor according to the present invention, and FIG. 15B is a sectional view thereof.

FIG. 16A is a perspective view, partially cut away, showing still another example of glucose sensor according to the present invention, and FIG. 16B is a sectional view thereof.

FIG. 17A is a perspective view, partially cut away, showing still another example of glucose sensor according to the present invention, and FIG. 17B is a sectional view thereof.

FIGS. 18A-18C are graphs showing the measurements of change of absorbance with time in Example 1.

FIGS. 19A-19C are graphs showing the measurements of change of absorbance with time in Example 2.

FIG. 20 is an entire perspective view showing a prior art glucose sensor.

### BEST MODE FOR CARRYING OUT THE INVENTION

Preferred embodiments of the present invention will be described below in detail as a first and a second embodiments with reference to the accompanying drawings.

The first embodiment of the present invention will now be described below.

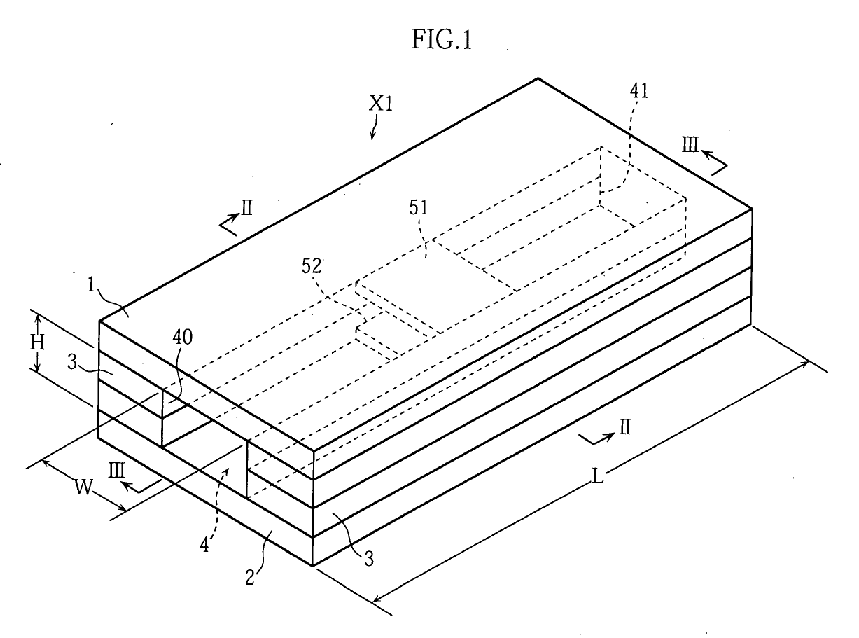

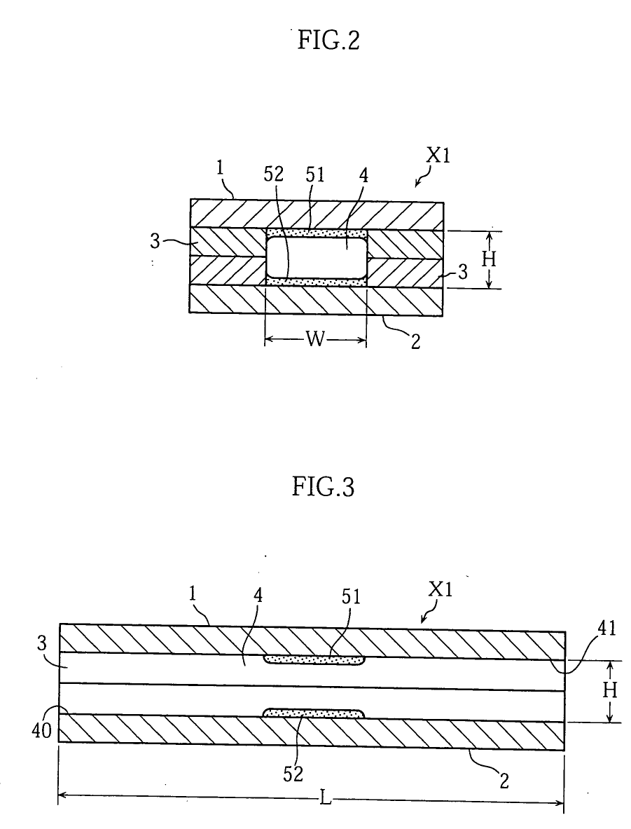

The glucose sensor X1 shown in FIGS. 1-3 is a disposable sensor designed to measure glucose concentration by colorimetry. The glucose sensor X1 comprises a first and a second plate members 1 and 2 bonded together via a pair of spacers 3. The glucose sensor X1 includes a capillary 4 defined by the above elements 1-3.

The first and the second plate members 1 and 2 are made of e.g. PET, PMMA or vinylon to be transparent. The plate members 1 and 2 are respectively provided with a first and a second reagent portions 51 and 52, which are accommodated in the capillary 4. Each of the reagent portions 51 and 52 is in a solid state soluble in blood, and at least one of the reagent portions 51 and 52 contains color former. Therefore, when blood is introduced into the capillary 4, a liquid phase reaction system including glucose and color former is established in the capillary 4.

Although various kinds of known color former can be used, it is preferable to use color former whose absorption wavelength upon color development due to electron transfer is deviated from the absorption wavelength of blood. For instance, as the color former, use may be made of MTT (3-(4,5-Dimethyl-2-thiazolyl)-2,5-diphenyl-2H-tetrazolium bromide).

The first and the second reagent portions 51 and 52 may contain an electron mediator or an oxidoreductase. In such a case, the electron transfer between glucose and color former proceeds quickly, whereby the measurement time can be shortened.

As the oxidoreductase, glucose dehydrogenase (GDH) or glucose oxidase (GOD) may be used, and typically, PQQGDH is used. As the electron mediator, use may be made of [Ru(NH₃)₆])Cl₃ K₃[Fe(CN)₆] or methoxy-PMS(5-methylphenazinium methylsulfate), for example.

The first and the second reagent portions 51 and 52 may have the same composition or may have different compositions. However, when an unstable reagent (highly reactive reagent) such as methoxy-PMS is used, it is preferable to separate such a reagent from other reagents. For instance, the unstable reagent is contained in the first reagent portion 51, whereas other reagents are contained in the second reagent portion 52.

The paired spacers 3 determine the distance between the first and the second plate members 1 and 2, i.e. the height H of the capillary 4 and also define the width W of the capillary 4. In the glucose sensor X1, the paired spacers 3 are spaced from each other by a predetermined distance, and the distance corresponds to the width W of the capillary 4. The thickness of each spacer 3 corresponds to the height H of the capillary 4.

The interior of the capillary 4 communicates with the outside through openings 40 and 41. The opening 40 is utilized for introducing blood into the capillary 4, whereas the opening 41 is utilized for discharging air from the capillary 4. With such a structure of the capillary 4, blood moves within the capillary 4 due to the capillary force generated in the capillary 4.

For instance, the width W of the capillary 4 is set to 0.05 mm to 10 mm, whereas the height (facing distance) H of the capillary 4 is set to 30 μm to 1 mm. Preferably, the height H of the capillary 4 is set to 300 μm, and more preferably, no greater than 200 μm.

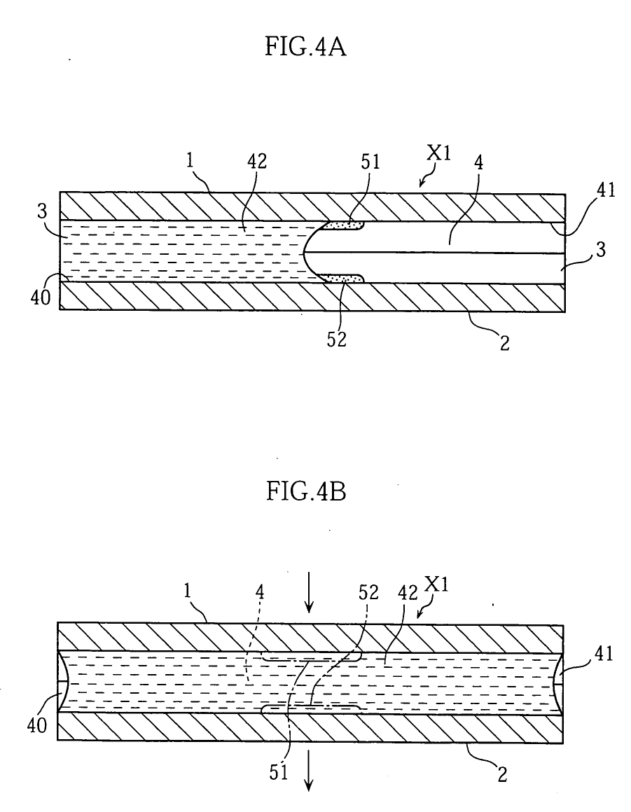

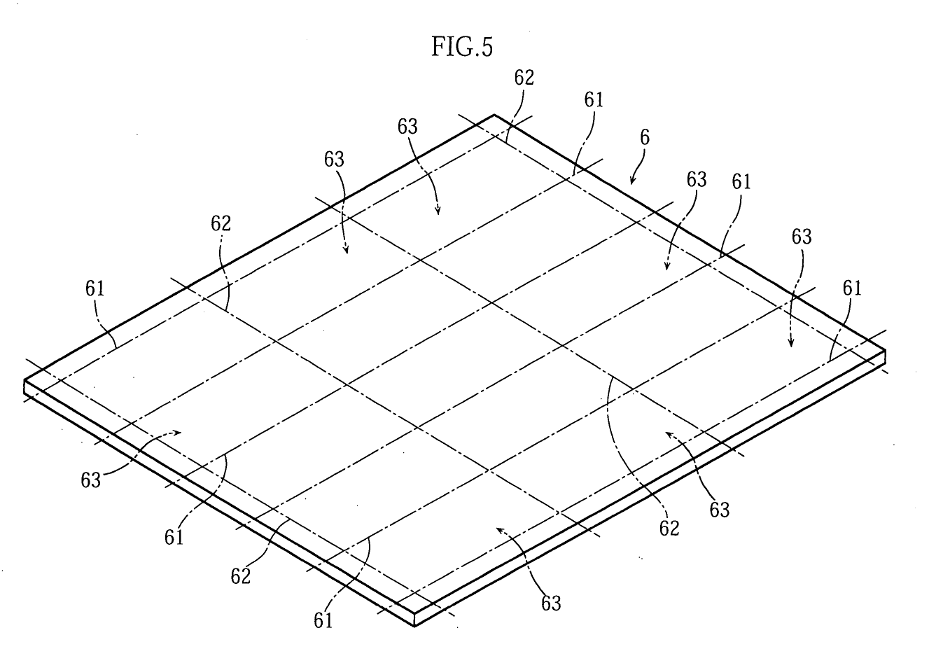

As shown in FIGS. 4A and 4B, in the glucose sensor X1, when blood is supplied to the capillary 4 through the opening 40, the blood moves within the capillary 4 due to the capillary force generated in the capillary 4. As the blood moves, the reagent portions 51 and 52 are dissolved by the blood, whereby a liquid phase reaction system 42 is established in the capillary 4. The movement of the blood stops when the blood reaches the opening 41.

In the liquid phase reaction system 42, electrons extracted from glucose are supplied to the color former to cause the color former to develop color, whereby the liquid phase reaction system 42 is colored. In the case where an oxidoreductase and an electron mediator are contained in the first or the second reagent portion 51, 52, the oxidoreductase reacts specifically with glucose in the blood to extract electrons from glucose, and the electrons are supplied to the electron mediator and then to the color former. Therefore, the degree of color development of the color former (degree of coloring of the liquid phase reaction system) relates to the amount of electrons extracted from glucose, i.e. the glucose concentration.

For instance, the degree of coloring of the liquid phase reaction system 42 is detected by irradiating the liquid phase reaction system 42 with light via the first plate member 1 and receiving the light passed through the liquid phase reaction system 42 and emitted from the second plate member 2. As the light to irradiate the liquid phase reaction system 42, use is made of light having a wavelength which the color former upon color development absorbs much. The glucose concentration can be computed based on the intensity of the incident light impinging on the liquid phase reaction system 42 and the intensity of the transmitted light transmitted through the liquid phase reaction system 42.

In the glucose sensor X1, the first and the second reagent portions 51 and 52 are provided separately in the first and the second plate members 1 and 2 so as to face each other. Therefore, as to the height direction of the capillary 4, the length of diffusion of the color former which is necessary for equalizing the concentration of the color former is relatively short.

Specifically, when a reagent portion is formed only at either one of the first and the second plate members 1 and 2, the concentration of the color former cannot be equalized until the color former is diffused to the surface of the plate member which is not formed with a reagent portion. On the other hand, when the reagent portions 51 and 52 are formed respectively at the first and the second plate members 1 and 2, the concentration of the color former is high at the surface of each plate member while being low at an intermediate portion between the plate members in the stage in which the reagent portions 51 and 52 begin to dissolve. Therefore, to equalize the concentration of the color former, it is only necessary to diffuse the color former to the intermediate portion between the first and the second plate members. Accordingly, in the case where both of the first and the second plate members 1 and 2 are formed with the reagent portions 51, 52, the diffusion length of the color former, which is necessary for equalizing the concentration of the color former, is half of that in the case where a reagent portion is formed only at either one of the plate members.

The above means that, the provision of the reagent portions 51 and 52 at the first and the second plate members 1 and 2 shortens the time necessary for dispersing the color former uniformly in the liquid phase reaction system, and hence, shortens the reaction time.

As for glucose, before the reaction, the concentration of unreacted glucose in the liquid phase reaction system is generally uniform. However, when the reaction proceeds to some degree, the concentration of unreacted glucose is low at a region where the concentration of the color former is high, whereas the concentration of unreacted glucose is high at a region where the concentration of the color former is low. Therefore, to shorten the measurement time, it is preferable to diffuse not only the color former but also unreacted glucose in the liquid phase reaction system to equalize the concentration. Since the first and the second reagent portions 51 and 52 are provided at the first and the second plate members 1 and 2 in the glucose sensor X1, the diffusion length of unreacted glucose necessary for equalizing the concentration is short because of the same reason as described above. Also from this point, it is concluded that the provision of the first and the second reagent portions 51 and 52 at the first and the second plate members 1 and 2 can shorten the reaction time.

As will become clearer also from Examples described later, in the glucose sensor X1, the measurement time can be further shortened by setting the facing distance H to no greater than 300 μm. By reducing the facing distance H, the diffusion length necessary for equalizing the concentration of the color former or unreacted glucose can be reduced with respect to the height direction. As a result, in the glucose sensor X1, the reaction necessary for causing the color former to develop color occurs easily. Therefore, the time taken for obtaining the intended reaction (coloring of the liquid phase reaction system) is shortened, whereby the measurement time can be shortened.

A method for making a glucose sensor X1 will be described with reference to FIGS. 5-8.

As shown in FIG. 5, to form a glucose sensor X1 (See FIGS. 1-3), a transparent substrate 6 is prepared. On the transparent substrate 6, a plurality of first cutting lines 61 and a plurality of second cutting lines 62 extending perpendicularly to each other are defined. Each of the regions surrounded by the cutting lines 61 and 62 is a glucose sensor formation region 63.

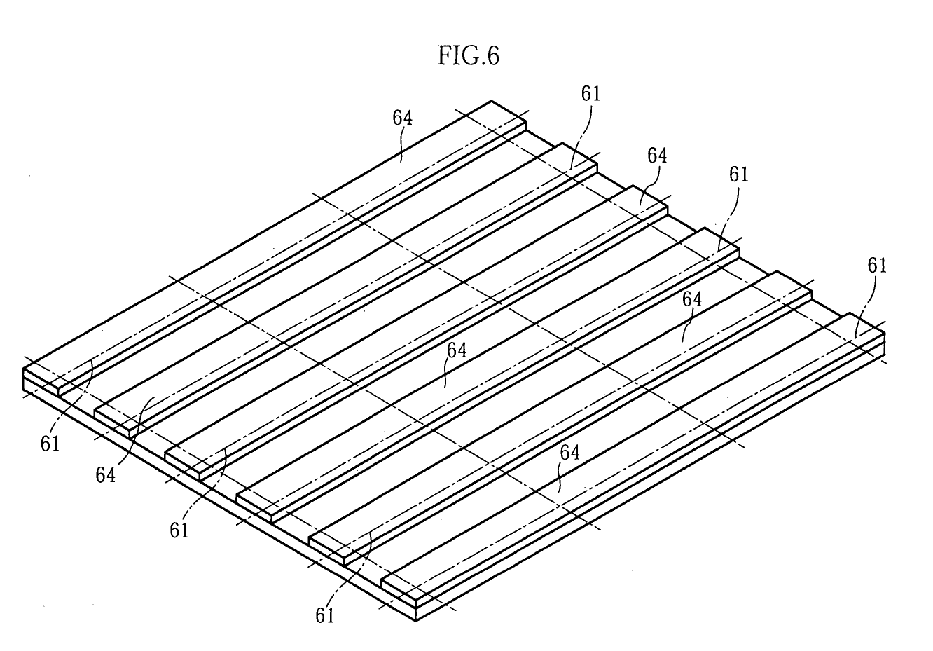

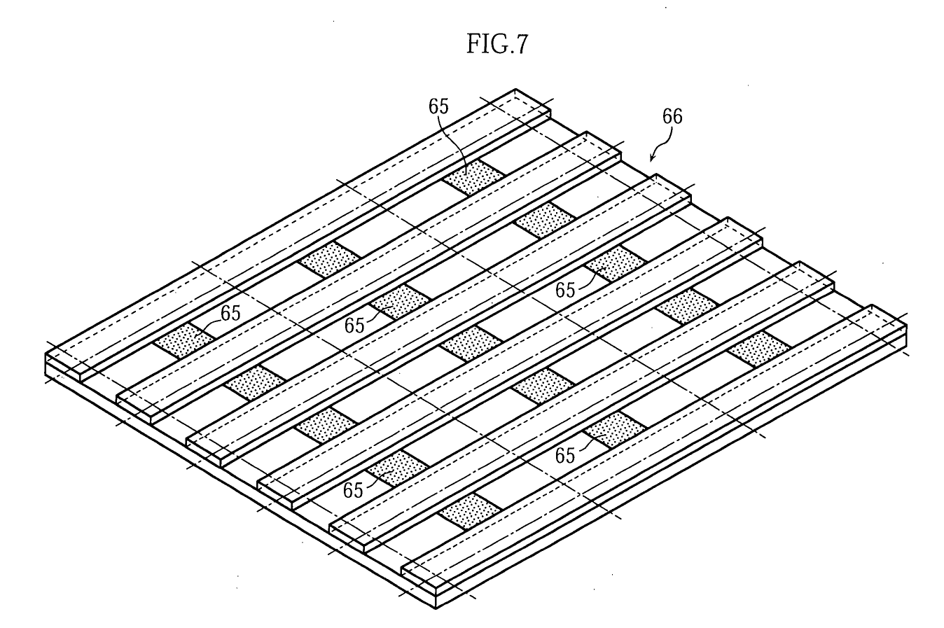

Subsequently, as shown in FIG. 6, a plurality of double-sided tapes 64 are bonded as spaced from each other by a predetermined distance to cover the first cutting lines 61. Then, as shown in FIG. 7, a reagent portion 65 is formed at each of the glucose sensor formation regions 63 to provide a primary intermediate product 66. Each reagent portion 65 may be formed by applying a reagent solution containing a color former, an oxidoreductase and an electron mediator, and then drying the reagent solution by air blowing.

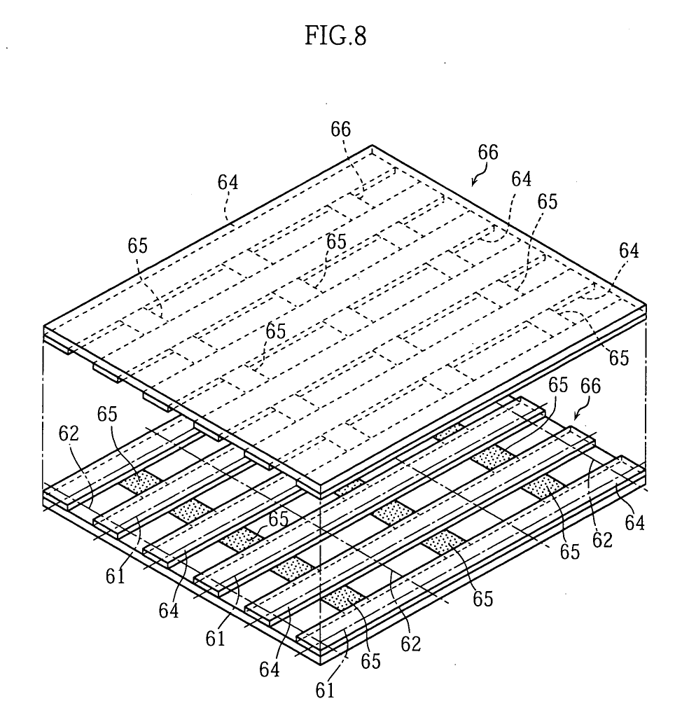

Similarly to the above, another primary intermediate product 66 is prepared through the process steps described with reference to FIGS. 5-7. Then, as shown in FIG. 8, the two primary intermediate products 66 are bonded together. Specifically, with the respective reagent portions 65 of the two primary intermediate products 66 facing each other, the two primary intermediate products are bonded to each other by utilizing the adhesive force of the double-sided tapes 64, whereby a secondary intermediate product (not shown) is provided. Finally, the secondary intermediate product is cut along the first and the second cutting lines 61 and 62, whereby glucose sensors X1 as shown in FIGS. 1-3 are obtained.

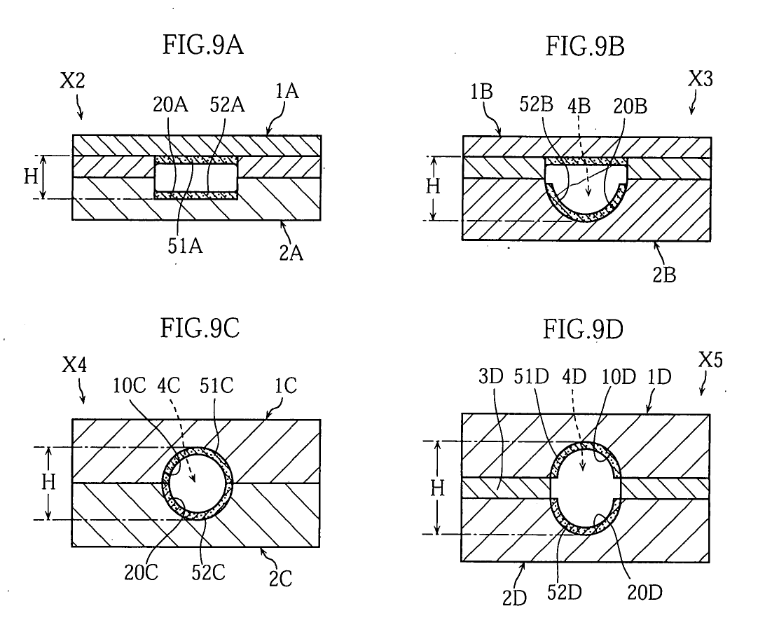

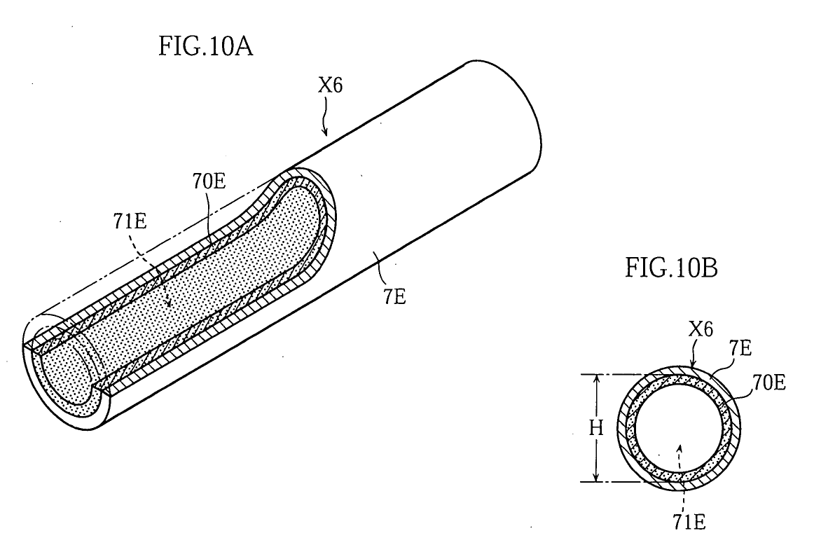

The glucose sensor of the present invention is not limited to the mode described in this embodiment but may be structured as shown in FIGS. 9A-9D and FIGS. 10A and 10B.

The glucose sensor X2 shown in FIG. 9A includes a first plate member 1A formed with a first reagent portion 51A, and a second plate member 2A formed with a recess 20A which is rectangular in cross section and in which a reagent portion 52A is formed. In the glucose sensor X2, the facing distance H is the distance between the bottom surface of the recess 20A and the first plate member 1A.

The glucose sensor X3 shown in FIG. 9B includes a capillary 4B which is semicircular in cross section. Specifically, in the glucose sensor X3, the second plate 2B is formed with a recess 20B having a semicircular cross section, and a second reagent portion 52B is formed in the recess 20B. In the glucose sensor X3, the facing distance H is the distance between the deepest portion of the recess 20B and the first plate member 1B.

The glucose sensor X4 shown in FIG. 9C includes a capillary 4C which is circular in cross section. Specifically, in the glucose sensor X4, the first and the second plate members 1C and 2C are respectively formed with recesses 10C and 20C which are semicircular in cross section, and a first and a second reagent portions 51C and 52C are formed in the recesses 10C and 20C, respectively.

Although the first and the second reagent portions 51C and 52 of the glucose sensor X4 are continuously formed in the figure, the reagent portions 51C and 52C may be separated from each other. In the glucose sensor X4, the facing distance H is the diameter of the capillary 4C in the thickness direction of the plate members 1C and 2C.

The glucose sensor X5 shown in FIG. 9D includes a capillary 4D which is an elongated circle in cross section. Specifically, in the glucose sensor 9D, the first and the second plate members 1D and 2D bonded together via a spacer 3D are respectively formed with recesses 10D and 20D which are semicircular in cross section, and a first and a second reagent portions 51D and 52D are respectively formed in the recesses 10D and 20D. The first and the second reagent portions 51D and 52D are separated from each other by the spacer 3D. In the glucose sensor X5, the facing distance H is the distance between the respective deepest portions of the recesses 10D and 20D.

The glucose sensor X6 shown in FIGS. 10A and 10B includes a transparent cylindrical tube 7E in which a reagent portion 70E is formed. Similarly to the glucose sensor X4 shown in FIG. 9C, the glucose sensor X6 includes a capillary 71E which is circular in cross section. However, the glucose sensor X6 differs from the glucose sensor X4 shown in FIG. 9C in that the capillary 71E is defined by the cylindrical tube 7E. In the glucose sensor X6, the facing distance H is the inner diameter of the circular tube 7E.

A second embodiment of the present invention will now be described below. In the figures to be referred to in this embodiment, the elements which are identical or similar to those of the first embodiment are designated by the same reference signs as those used for the first embodiment.

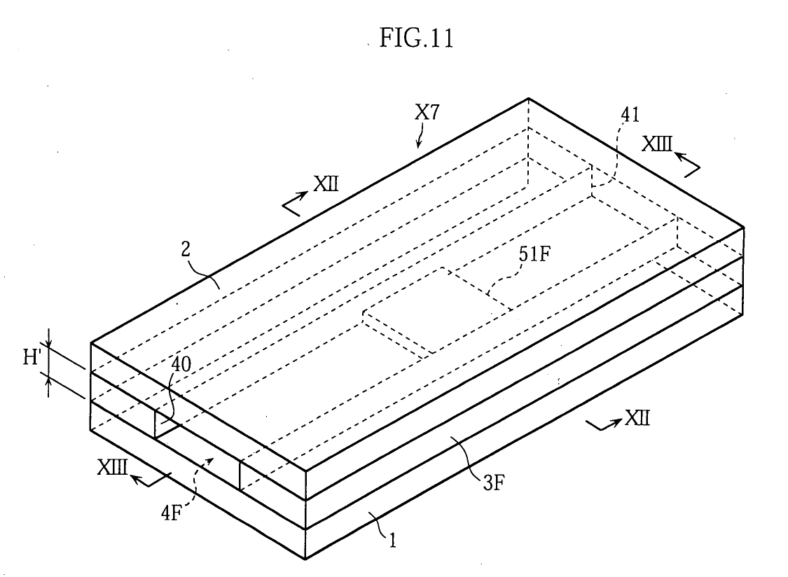

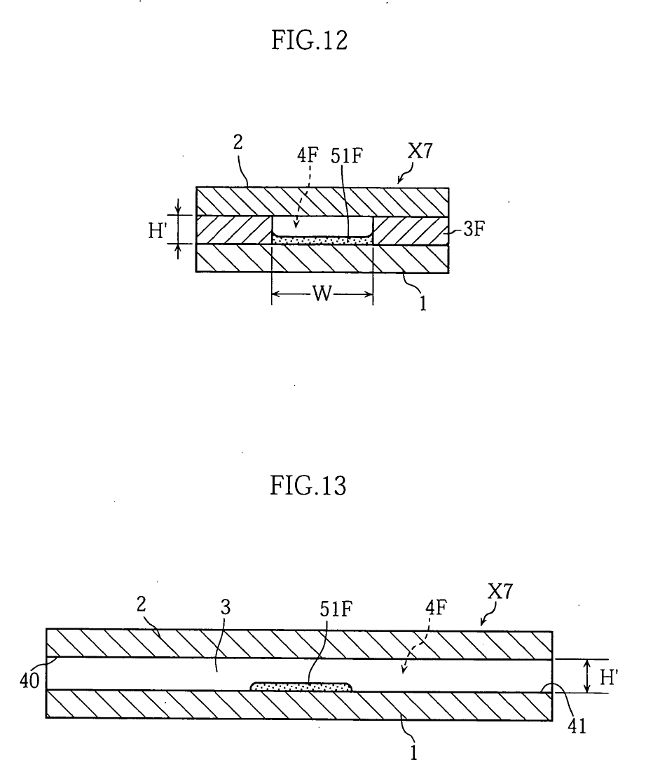

The glucose sensor X7 shown in FIGS. 11-14 is a disposable sensor designed to measure glucose concentration by colorimetry, and the basic structure is similar to that of the foregoing glucose sensor X1 (FIGS. 1-3). Specifically, the glucose sensor X7 includes a first and a second plate members 1 and 2 bonded together via a pair of spacers 3F. The elements 1, 2 and 3F define a capillary 4F extending in the longitudinal direction of the first and the second plate members 1 and 2.

The glucose sensor X7 differs from the foregoing glucose sensor X1 (FIGS. 1-3) in height H′ of the capillary 4F and arrangement of the reagent portion 51F.

The height (facing distance) H′ of the capillary is set to no greater than 150 μm. Preferably, the height H′ of the capillary 4F is set to no greater than 100 μm, and more preferably, no greater than 75 μm. However, when a sample like whole blood which contains blood cells (solid components) is used, it is preferable to set the height H′ of the capillary 4F to no smaller than 30 μm to reliably introduce the sample (blood) into the capillary 4F. The height H′ of the capillary 4F can be adjusted by adjusting the thickness of the spacers 3F.

The reagent portion 51F is provided only at the first plate member 1. The reagent portion 51F is in a solid state soluble in blood and contains a color former, an electron mediator and an oxidoreductase, for example. As the color former, the electron mediator and the oxidoreductase, those described in the first embodiment may be used.

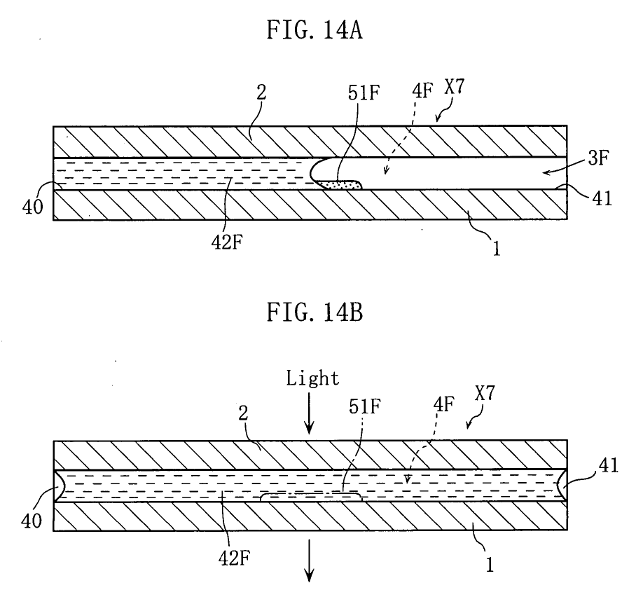

As shown in FIGS. 14A and 14B, in the glucose sensor X7, when blood is supplied to the capillary 4F through the opening 40, the blood moves within the capillary 4F due to the capillary force generated in the capillary 4F. At this time, the reagent portion 51F is dissolved by the blood, whereby a liquid phase reaction system 42 is established in the capillary 4. In the liquid phase reaction system 42F, the color former develops color, and the degree of color development (degree of coloring of the liquid phase reaction system) is detected similarly to the foregoing glucose sensor X1 (See FIGS. 1-3).

As will become clearer also from Examples described later, in the glucose sensor X7, the measurement time can be shortened by setting the facing distance H′ further smaller, i.e., to no greater than 150 μm. Specifically, in the glucose sensor X7, the diffusion length of an intended component (color former, oxidoreductase, electron mediator) contained in the reagent portion 51F, which is necessary for equalizing the concentration of the intended component, becomes short with respect to the height direction. Further, also when glucose is consumed by reaction, the diffusion length for uniformly dispersing unreacted glucose becomes shorter than that of ordinary glucose sensors with respect to the height direction. As a result, in the glucose sensor X7, the reaction necessary for causing the color former to develop color occurs easily. Therefore, the time taken for obtaining the intended reaction (coloring of the liquid phase reaction system) is shortened, whereby the measurement time can be shortened.

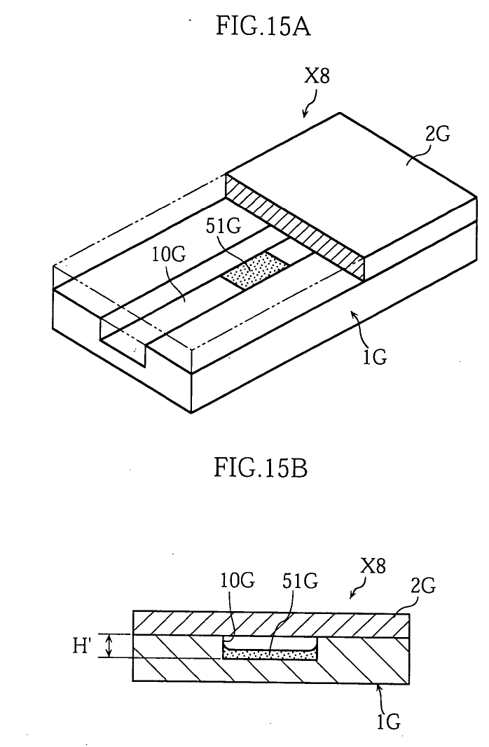

The glucose sensor of the present invention is not limited to the mode described in this embodiment and may be structured as shown in FIGS. 15-17, for example.

The glucose sensor X8 shown in FIGS. 15A and 15B includes a first plate member 1G formed with a recess 10G which is rectangular in cross section, and a reagent portion 51G is formed at the bottom surface of the recess 10G. As shown in FIG. 15B, in the glucose sensor X8, the facing distance H′ is the distance between the bottom surface of the recess 10G and the second plate member 2G.

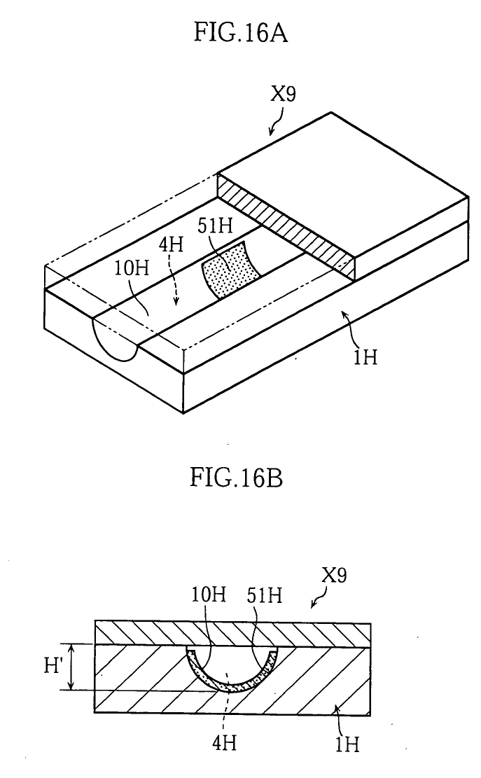

The glucose sensor X9 shown in FIGS. 16A and 16B includes a capillary 4H which is semicircular in cross section. Specifically, the first plate member 1H is formed with a recess 10H which is semicircular in cross section, and a reagent portion 51H is formed at the inner surface of the recess 10H. As shown in FIG. 16B, in the glucose sensor X9, the facing distance H′ is the depth of the recess 10H.

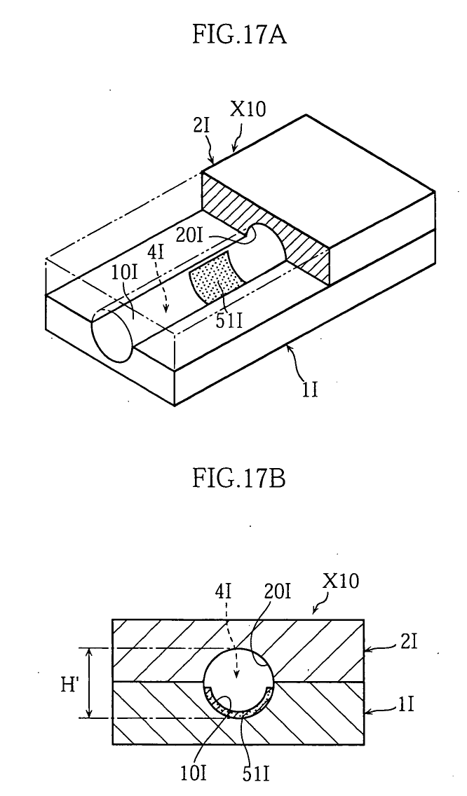

The glucose sensor X10 shown in FIGS. 17A and 17B includes a capillary 4I which is circular in cross section. Specifically, in the glucose sensor X10, the first and the second plate members 1I and 2I are respectively formed with recesses 10I and 20I which are semicircular in cross section, and a reagent portion 51I is formed in the recess 10I of the first plate member 1I. As shown in FIG. 17B, in the glucose sensor X10, the facing distance H′ is the diameter of the capillary 4I.

In each of the glucose sensors X8-X10 shown in FIGS. 15-17, a spacer is not interposed between the first and the second plate members. In the structure in which a spacer is interposed, the facing distance becomes the sum of the above-described dimension and the thickness of the spacer.

In the first and the second embodiments, a glucose sensor is described which is designed to measure glucose concentration based on the strength of incident light and transmitted light. However, the present invention is also applicable to a glucose sensor which is designed to measures glucose concentration based on incident light and reflected light. Particularly, the glucose sensor according to the first embodiment of the present invention is applicable not only to a glucose sensor for measuring glucose concentration by colorimetry but also to a glucose sensor for measuring glucose concentration by an electrode method.

Although the glucose sensors X1-X10 of the foregoing embodiments are designed to move a sample by a capillary force, the sample may be moved by utilizing the motive power of a pump, for example. Further, a structure for moving a sample need not necessarily be employed.

The present invention is also applicable to the measurement of a component other than glucose which is contained in blood, such as cholesterol, for example. Further, the present invention is also applicable to the analysis of a sample other than blood, such as urine, for example.

### EXAMPLES

### Example 1

In this example, the influence of the height (facing distance) of a capillary of a glucose sensor on the measurement time when blood was used as a sample was examined by measuring the change of absorbance with time.

[Glucose Sensor Used in Example 1]

In this example, three kinds of glucose sensors (1)-(3) were used. The glucose sensors (1)-(3) are basically the same in structure but made different in height of the capillary (facing distance) by adjusting the thickness of respective double-sided tapes (spacers) as shown in Table 1.

Each of the glucose sensors (1)-(3) was prepared as follows. First, on a first transparent plate made of PET and having dimensions of 10 mm×30 mm×0.2 mm, a pair of double-sided tapes spaced from each other by 3 mm were bonded. The double-sided tapes define the thickness of the capillary, and the thickness of the double-sided tapes used for each glucose sensor (1)-(3) is as shown in Table 1. Subsequently, a reagent solution having the composition shown in Table 1 was applied to a 3 mm×3 mm region between the paired double-sided tapes, and then the reagent solution was dried by air blowing (30° C., 10% Rh), whereby a reagent portion was provided. The amount of the reagent solution applied in forming each glucose sensor (1)-(3) is as shown in Table 1. The application amount of the reagent solution is set in accordance with the capacity of respective capillaries so that the glucose sensors (1)-(3) become equal in reagent concentration when blood is introduced into the capillaries. Subsequently, a second transparent plate made of PET and having dimensions of 10 mm×30 mm×0.2 mm was bonded to the first transparent plate via the double-sided tapes. In this way, glucose sensors (1)-(3) to be used in this Example were obtained.

TABLE 1
Structure of glucose sensors used in Example 1

| | Thickness of | | | | | |
|---|---|---|---|---|---|---|
| | double-sided | Reagent solution composition | | | | Application |
| | tape | Enzyme | Mediator | Color former | Buffer | amount |
| Glucose | 200 μm | PQQGDH | Methoxy- | MTT | PIPES | 4 μL |
| sensor | | 1000 | PMS | (40 mM) | (pH7) | |
| (1) | | (U/Ml) | (3 mM) | | (80 mM) | |
| Glucose | 100 μm | | | | | 2 μL |
| sensor | | | | | | |
| (2) | | | | | | |
| Glucose | 60 μm | | | | | 1 μL |
| sensor | | | | | | |
| (3) | | | | | | |

In Table 1, PQQGDH is the abbreviation of glucose dehydrogenase (GDH) having pyrroloquinoline quinone (PQQ) as a coenzyme, PMS is the abbreviation of 5-methylphenazinium methylsulfate, MMT is the abbreviation of 3-(4,5-Dimethyl-2-thiazolyl)-2,5-diphenyl-2H-tetrazolium bromide and PIPES is the abbreviation of piperazine-1,4-bis(2-ethanesulfonic acid).

[Measurement of Absorbance]

In this Example, the absorbance in each of the glucose sensors (1)-(3) was measured over time with respect to blood having glucose concentration of about 0 mg/dL, 200 mg/dL, 400 mg/dL or 600 mg/dL.

In the measurement of absorbance, the region provided with the reagent portion was irradiated with light along the thickness direction, and the light transmitted through the glucose sensor was received. In the light irradiation, 630 nm light was directed by using a light emitting diode. The transmitted light was received by a photodiode. The absorbance was computed by the formula below:
ABS(absorbance)=log (l₁/l₂)

In the above formula, l₁ represents the intensity of incident light, whereas l₂ represents the intensity of transmitted light.

[Measurement Results and Evaluation]

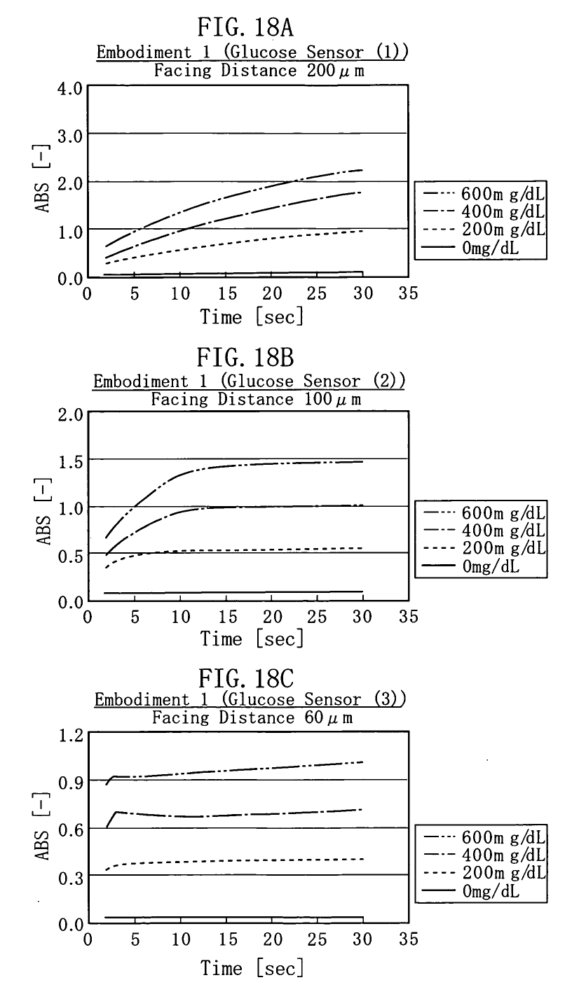

The measurement results of change of absorbance with time in each of the glucose sensors (1)-(3) are respectively shown in FIGS. 18A-18C.

As shown in FIG. 18A, in the glucose sensor (1) in which the thickness (facing distance) of the double-sided tapes (capillary) is 200 μm, the change of the absorbance with time is small. In the case of blood having glucose concentration of 400 mg/dL or 600 mg/dL, the absorbance does not become sufficiently close to the maximum absorbance even after the lapse of 30 seconds from the start of blood introduction. Therefore, in the glucose sensor (1), it is difficult to measure the glucose concentration within 30 seconds after the start of the blood introduction. To accurately measure the glucose concentration within 30 seconds after the start of the blood introduction, the measurement range cannot help being narrowed.

As shown in FIG. 18B, in the glucose sensor (2) in which the thickness (facing distance) of the double-sided tapes (capillary) is 100 μm, the absorbance becomes sufficiently close to the maximum absorbance after the lapse of about 10 seconds from the start of the blood introduction even when the glucose concentration is 600 mg/dL. Therefore, in the glucose sensor (2), the accurate measurement of glucose concentration is possible after the lapse of about 10 seconds from the start of the blood introduction at least in the glucose concentration range of 0 to 600 mg/dL.

As shown in FIG. 18C, in the glucose sensor (3) in which the thickness (facing distance) of the double-sided tapes (capillary) is 60 μm, the absorbance becomes sufficiently close to the maximum absorbance after the lapse of about five seconds from the start of the blood introduction even when the glucose concentration is 600 mg/dL. Therefore, in the glucose sensor (3), the accurate measurement of the glucose concentration is possible after the lapse of about five seconds from the start of the blood introduction at least in the glucose concentration range of 0 to 600 mg/dL.

As will be understood from the above results, when the reagent concentration of the liquid phase reaction system is the same, the time necessary for the absorbance to become close to the maximum value becomes shorter as the thickness (facing distance) of the double-sided tapes (capillary) becomes smaller. Therefore, in a glucose sensor, the measurement time can be shortened by reducing the distance (facing distance) of the reagent portions in the capillary in the normal direction, e.g. to no greater than 150 μm, and more preferably, no greater than 75 μm.

### Example 2

In this example, the influence of the configuration of a reagent portion on the measurement time when a glucose solution was used as a sample was examined by measuring the change of absorbance with time.

[Glucose Sensor Used in Example 2]

In this example, three kinds of glucose sensors (4)-(6) shown in Table 2 were used.

In the glucose sensor (4), a reagent portion (See FIGS. 1-3) is formed at each of the first and the second plate members. The glucose sensor (4) was prepared by bonding a pair of double-sided tapes on a first plate member and forming a first reagent portion between the double-sided tapes while bonding a pair of double-sided tapes on a second plate member and forming a second reagent portion between the double-sided tapes, and then bonding the first and the second plate members together so that the first and the second reagent portions face each other. As to the glucose sensor (4), only the elements which differ from those of the glucose sensors (1)-(3) are described in Table 2, and other informations which are not described in Table 2 are the same as those of the glucose sensors (1)-(3).

Each of the glucose sensors (5) and (6) includes a reagent portion formed at the first plate member only, and was made similarly to the glucose sensors (1)-(3) of Example 1 to have the structure shown in Table 2 below.

TABLE 2
Structure of glucose sensors used in Example 2

| | Thickness of | Reagent solution composition | | | | |
|---|---|---|---|---|---|---|
| | double-sided | | | Color | | Application |
| | tape | Enzyme | Mediator | former | Buffer | amount |
| Glucose | 120 μm | PQQGDH | [Ru(NH₃)₆]Cl₃ | MTT | PIPES | 1 μL for |
| sensor | (60 μm × 2) | 1000 | (10 mM) | (40 mM) | (pH7) | each |
| (4) | | (U/mL) | | | (80 mM) | substrate |
| Glucose | 120 μm | | | | | 2 μL |
| sensor | (60 μm × 2) | | | | | |
| (5) | | | | | | |
| Glucose | 60 μm | | | | | 1 μL |
| sensor | | | | | | |
| (6) | | | | | | |

[Measurement Results and Evaluation]

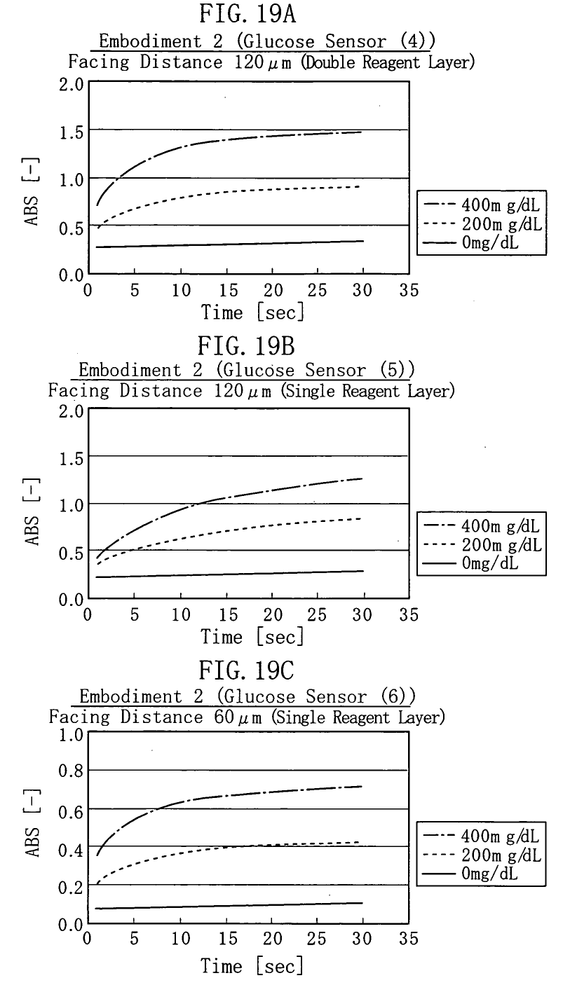

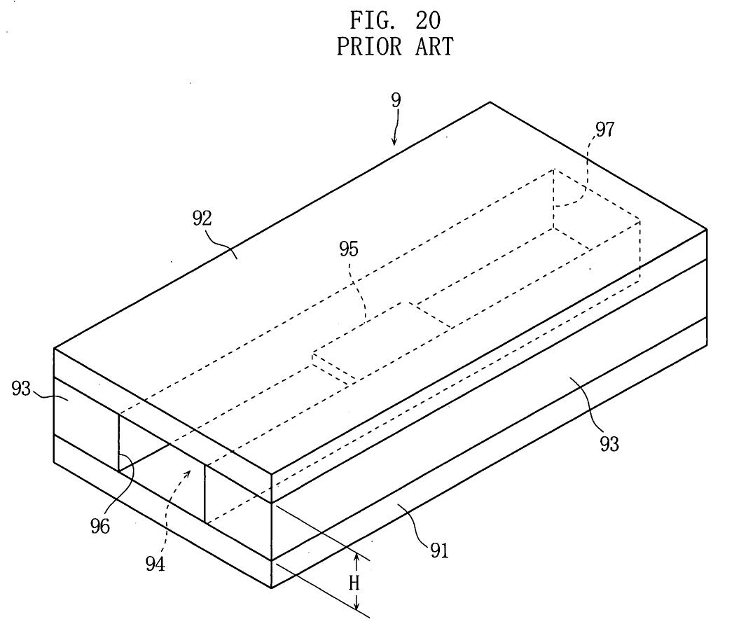

In this Example, the absorbance was measured over time by using the glucose sensors (4)-(6) similarly to Example 1. The absorbance was measured with respect to three kinds of glucose solutions which differ in concentration (0 mg/dL, 200 mg/dL, 400 mg/dL). The measurement results of change of absorbance with time in each of the glucose sensors (4)-(6) are respectively shown in FIGS. 19A-19C.

As shown in FIG. 19A, in the glucose sensor (4), the absorbance becomes sufficiently close to the maximum absorbance after the lapse of about 10 seconds from the start of the blood introduction even when the glucose concentration is 600 mg/dL. Therefore, with a glucose sensor which includes two reagent portions facing each other like the glucose sensor (4), the accurate measurement of glucose concentration is possible after the lapse of about 10 seconds from the start of the blood introduction at least in the glucose concentration range of 0 to 600 mg/dL.

As shown in FIG. 19B, in the glucose sensor (5), the change of absorbance with time is small. In the case of the glucose solution having the glucose concentration of 600 mg/dL, the absorbance does not become sufficiently close to the maximum absorbance even after the lapse of 30 seconds from the start of blood introduction. Therefore, in the glucose sensor (5) which includes a reagent portion on one side only, it is difficult to measure the glucose concentration within 30 seconds after the start of the blood introduction even when the height (facing distance) of the capillary and the composition of the reagent portion are the same as those of the glucose sensor (4). To accurately measure the glucose concentration within 30 seconds after the start of the blood introduction, the measurement range cannot help being narrowed.

As shown in FIG. 19C, with respect to the glucose sensor (6), the results similar to those of the glucose sensor (4) were obtained.

In this way, the glucose sensor (4) which includes two reagent portions facing each other have substantially the same advantages as those of a glucose sensor having a small facing distance (glucose sensors (2) and (3) of Example 1). This means that the provision of reagent portions facing each other provides the following advantages. Firstly, the measurement time can be shortened even when the facing distance is relatively large. Secondly, by setting the facing distance relatively small, the measurement can be performed in a shorter period of time than is possible in the case where a reagent portion is formed on one plate member only. Therefore, with a glucose sensor including two reagent portions facing each other, the measurement time can be considerably shortened.

1. An analyzing tool comprising: a reaction space in which a particular component of a sample and a reagent react with each other; and a reagent portion which is arranged in the reaction space and which dissolves when the sample is supplied to the reaction space;
wherein the reagent portion includes a first part and a second part facing each other and provided on a defining surface defining the reaction space.

2. The analyzing tool according to claim 1, wherein the first part and the second part are separated from each other.

3. The analyzing tool according to claim 1, wherein the first part and the second part differ from each other in composition.

4. The analyzing tool according to claim 1, wherein the reagent portion includes a color-developing reagent to perform sample analysis by colorimetry.

5. The analyzing tool according to claim 1, wherein the defining surface includes a first region at which the first part is provided, and a second region at which the second part is provided, the second region facing the first region in a direction normal to the first region; and
wherein a facing distance between the first region and the second region is no greater than 300 μm.

6. The analyzing tool according to claim 5, wherein the facing distance is no smaller than 30 μm.

7. The analyzing tool according to claim 5, further comprising a first plate member in which the first region is included, and a second plate member in which the second region is included, the second plate member defining the reaction space together with the first plate member.

8. The analyzing tool according to claim 7, further comprising a spacer for bonding the first plate member and the second plate member to each other and defining the reaction space together with the plate members;
wherein the facing distance is determined by the spacer.

9. The analyzing tool according to claim 1, wherein the reaction space is designed to move the sample by a capillary force generated in the reaction space.

10. The analyzing tool according to claim 1, wherein blood is used as the sample.

11. A method for making an analyzing tool, the method comprising:
a first reagent portion forming step for forming at least one first reagent portion at a first substrate;
a second reagent portion forming step for forming at least one second reagent portion at a second substrate; and
an intermediate product forming step for forming an intermediate product by bonding the first substrate and the second substrate to each other in a manner such that the first and the second reagent portions face each other.

12. The method for making an analyzing tool according to claim 11, wherein a plurality of first reagent portions are formed at the first substrate in the first reagent portion forming step;
wherein a plurality of second reagent portions are formed at the second substrate in the second reagent portion forming step; and
wherein the method further comprises a cutting step for cutting the intermediate product into pieces each including at least one of the first reagent portions and at least one of the second reagent portions.

13. The method for making an analyzing tool according to claim 11, wherein the first reagent portion and the second reagent portion differ from each other in composition.

14. The method for making an analyzing tool according to claim 11, wherein the first reagent portion and the second regent portion have a same or substantially same composition.

15. The method for making an analyzing tool according to claim 11, further comprising a step performed before the intermediate product forming step for mounting a spacer on at least one of the first and the second substrates, the spacer being mounted on a surface to be formed with the first reagent portion or a surface to be formed with the second reagent portion.

16. An analyzing tool comprising a reaction space in which a particular component of a sample reacts with a reagent for analyzing the particular component by colorimetry,
wherein the reaction space is defined by a defining surface which includes: a reagent retaining region for retaining a reagent; and a facing region which faces the reagent retaining region in a direction normal to the reagent retaining region and which does not retain a reagent; and
wherein a facing distance between the reagent retaining region and the facing region is no greater than 150 μm.

17. The analyzing tool according to claim 16, wherein the facing distance is no greater than 100 μm.

18. The analyzing tool according to claim 17, wherein the facing distance is no greater than 75 μm.

19. The analyzing tool according to claim 16, wherein the facing distance is no smaller than 30 μm.

20. The analyzing tool according to claim 16, wherein the reaction space is designed to move the sample.

21. The analyzing tool according to claim 20, wherein the reaction space is designed to move the sample by a capillary force generated in the reaction space.

22. The analyzing tool according to claim 16, further comprising a first plate member in which the reagent retaining region is included, and a second plate member in which the facing region is included, the second plate member defining the reaction space together with the first plate member.

23. The analyzing tool according to claim 22, further comprising a spacer for bonding the first plate member and the second plate member to each other and defining the reaction space together with the plate members;
wherein the facing distance is determined by the spacer.

24. The analyzing tool according to claim 16, wherein blood that contains blood cells is used as the sample.
